(19) United States
(12) Patent Application Publication
(10) Pub. No.: US 2005/0265023 A1
(43) Pub. Date: Dec. 1, 2005

(54) Lamp system with green-blue gas-discharge lamp and yellow-red led

(75) Inventor: Robert Scholl, Roetgen (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/521,866

(22) PCT Filed: Jul. 15, 2003
(86) PCT No.: PCT/IB03/02982

§ 371 Date: Jan. 21, 2005

(30) Foreign Application Priority Data
Jul. 25, 2002 (DE) 102 33 768.3

(51) Int. Cl. F21S 19/00

(52) U.S. Cl. 362/229

(57) ABSTRACT

The invention relates to a lamp system having—a gas-discharge lamp with a color point in the green-blue,—an LED with a color point in the yellow-red, and—an optical component for additive mixing of the light from the gas-discharge lamp and the LED, and to a corresponding method of illumination. A blue and green emitting fluorescent lamp is particularly suitable as gas-discharge lamp, and a red-yellow-emitting AlGaInP LED or a red-emitting AlGaAs LED as LED. Through additive mixing of the light from these high-efficiency light sources, the invention provides a highly efficient light source affording good color rendering, which contains all three primary colors and is particularly suited to the highly efficient generation of white light.

The invention relates to the field of lighting, for example lighting for offices and homes or for the illumination of sales displays. In practice a number of known light sources are used for this purpose, such as filament lamps, halogen lamps, low-pressure and high-pressure gas discharge lamps and of late also light-emitting diodes (LEDs).

By means of such light sources and sometimes by mixing multiple individual sources it is possible to produce lamp systems of widely varying light colorations, light outputs and color renditions. However, the said light sources have widely differing efficiencies in converting the electrical energy used to supply the source into the light output produced. These efficiencies are usually between 10 lm/W for a filament lamp and 120 lm/W for a fluorescent-lamp, that is in this case a low-pressure mercury vapor lamp, the primarily generated mercury radiation of which is converted into visible light by suitably fluorescent phosphors. At the same time, although there are yet more efficient light sources, such as the SOX lamps still sometimes used for street lighting, some with an output of more than 200 lm/W, for example, these light sources are not white and do not possess good color rendition. An SOX lamp, for example, essentially only emits the yellow sodium line.

In addition to the suitable choice of light coloration, light output and color rendition combined with high efficiency, variable-color lamp systems have recently been proposed, which allow a user, at least to some extent, to control in particular the light coloration of the lamp systems. Thus DE 200 07 134 U1 proposes a lamp system having a white fluorescent lamp, for example, together with one or more colored LEDs, the light from which is additively mixed by suitable means of deflection and/or diffusion into a full homogeneous light. By varying the output of the colored LEDs, a user can to some extent influence their light output and hence also the color point of the overall lamp system. U.S. 2001/0005319 A1 uses red, green and blue LEDs, for example, to produce white or colored light in one lamp system and discloses an easy-to-use control device by means of which a user can control the light coloration of the lamp system within wide limits.

An object of the present invention is now to develop this prior art so as to provide a high-efficiency lamp system which simultaneously affords good color rendition and in particular a high-efficiency white lamp system.

This object is achieved, on the one hand, by a lamp system having
a gas-discharge lamp with a color point in the green-blue,
an LED with a color point in the yellow-red, and
an optical component for additive mixing of the light from the gas-discharge lamp and the LED,
and on the other by a method of illumination comprising the following stages:
   generation of light with a color point in the green-blue by means of a gas-discharge lamp,
   generation of light with a color point in the yellow-red by means of an LED, and
   additive mixing of the light from the gas-discharge lamp and the LED by means of an optical component.

The principle of the invention is therefore based on the finding that gas-discharge lamps possess high efficiencies in the green-blue and LEDs possess high efficiencies in the yellow-red and that through additive mixing of these two types of light sources it is possible to obtain a high-efficiency lamp system which simultaneously affords good color rendition and in particular a high-efficiency white lamp system. In particular, through the use of a green-blue gas-discharge lamp instead of a white fluorescent lamp, a significantly higher efficiency is obtained than in the prior art disclosed in DE 200 07 134 U1.

The dependent claims demonstrate particularly advantageous developments of the invention.

A fluorescent lamp, such as a low-pressure mercury vapor lamp, for example, may be used as gas-discharge lamp. In such low-pressure mercury vapor lamps the electrical energy is first (partially) converted into ultraviolet mercury radiation, in the 254 nm line, for example. This ultraviolet radiation can then be converted by the blue phosphor BAM (emission around 450 nm) and the green phosphor CAT (emission around 542 nm) into visible green-blue radiation.

For one embodiment of the invention, however, other gas-discharge lamps are in principle feasible. For example, many high-pressure gas discharge lamps also possess high efficiencies in the green-blue and are therefore suitable for a lamp system according to the invention. Alternative radiating substances to mercury have also recently been discovered, which despite their as yet low efficiencies show highly promising potential by virtue of their inherently lower Stokes shifts. Reference will be made here to the molecular radiation sources disclosed by EP 1 187 174 A2 and the unpublished DE 101 29 464.6 as representative examples of these substances.

Possible LEDs, for example, are an inorganic red-yellow emitting AlGaInP LED (emission in the range 600-620 nm) or an inorganic red emitting AlGaAs LED. Since these LEDs possess higher efficiencies than gas-discharge lamps in converting the electrical energy into red-yellow or red radiation, through additive mixing of the green-blue with the red-yellow light sources in accordance with the invention, a high-efficiency light source is obtained with good color rendition. This approach leads, in particular, to a lamp system with white light coloration having an efficiency which exceeds the aforementioned peak value of 120 lm/W for hitherto known white light sources giving good color rendition. In addition to these types of LED just mentioned, however, consideration may naturally also be given to all other types having sufficiently high efficiencies in the yellow-red.

It is possible to determine the light coloration of a lamp system according to the invention by varying the light outputs of the individual light sources involved in the mixing. To do this, the electrical input of the gas-discharge lamp and/or the LEDs can firstly be varied, the LEDs being particularly easy to trigger. Secondly, as an addition or as an alternative to this, controllable mixing components are also feasible, such as switchable filters or moveable diaphragms, reflectors, lenses, diffusion elements or the like. As already mentioned, a method of controlling the light coloration of the overall lamp system easily operated by the end user is disclosed by U.S. 2001/0005319 A1, to which end this specification will hereby be incorporated in its entirety into the present application. Various possible ways of arranging the light sources in a housing and the choice of mixing components are, as stated above, disclosed by DE 200 07 134 U1, which to this end will hereby also be incorporated into the application.

The invention will be further described with reference to examples of embodiments shown in the drawings to which, however, the invention is not restricted. In the drawings:

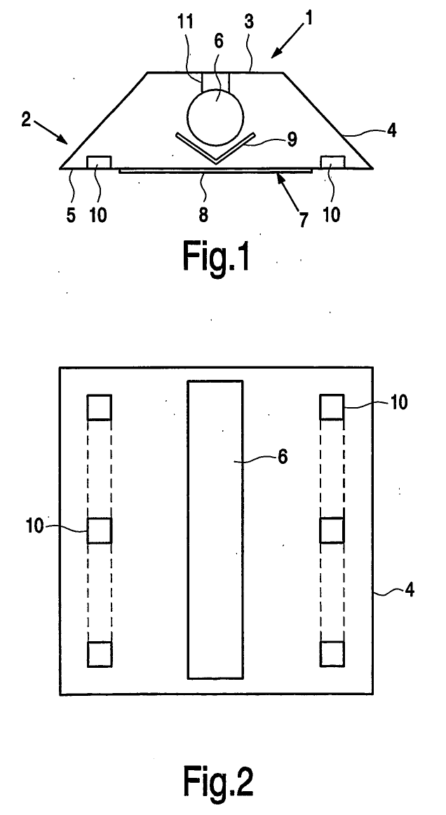

FIG. 1 shows a sectional view through a lamp system according to the invention, and

FIG. 2 shows a plan view from below of the lamp system in FIG. 1.

A fluorescent lamp, in particular a low-pressure mercury vapor lamp may be selected as gas-discharge lamp. As already stated, in the case of such low-pressure mercury vapor lamps the electrical energy is first (partially) converted into the ultraviolet mercury radiation of the 254 nm-line. This efficiency of this conversion is approximately 60%. With regard to the efficiency of the BAM and CAT phosphors for the conversion of UV light into visible light, allowance must first be made for the fact that the conversion of a UV quantum at 254 nm into a visible blue (at 450 nm) or a visible green (at 542 nm) leads to the energy difference between these quanta (between 254 and 450 or between 254 and 542 nm) being lost in the form of the so-called Stokes shift (single-quantum phosphors). In addition to this there may be other quantum loss mechanisms, although these are of lesser significance. The so-called physical efficiency of the conversion of electrical energy into visible radiation in such a lamp is therefore about 28% for green (at approximately 542 nm) and 34% for blue (at approximately 450 nm).

Taking further account of the different ocular sensitivities V(λ) at different wavelengths λ, the physical efficiencies are multiplied by “V(λ)*683 lm/W” in order to obtain the lighting efficiencies. Taking V(542 nm) as =0.98, the latter amount to 185 lm/W in the green and taking V(450 nm) as =0.044 they amount to 10 lm/W in the blue.

In addition to the green and the blue phosphor, a typical warm white fluorescent lamp (color: 83, Ra value: 80, color temperature: 3000K) also uses a red phosphor, such as YOX (emission around 610 nm) and the electrical energy is divided up into red:green:blue in the ratio 55:40:5. Owing to the large Stokes shift in the red, the physical efficiency there, however, is only 25%, giving a lighting efficiency, where V(610 nm)=0.5, of 85 lm/W. The overall efficiency of such a lamp is therefore only (0.55*85+0.4*185+0.05*10)lm/W=120 lm/W, which corresponds to the efficiency initially quoted.

The efficiency of the overall lamp system can therefore be increased if a more efficient LED is used in place of the red phosphor (around 610 nm) with a lighting efficiency of 85 lm/W. The yellow-red AlGaInP LEDs now available, which emit in the range between 600-620 nm, already afford efficiencies in excess of 100 lm/W, which already makes them superior to the 85 lm/W of the red phosphor, thereby leading to more efficient overall lamp systems. Experts predict that in the near future these LEDs will attain efficiencies of up to 150 lm/W, so that the efficiency in the red would increase by a factor of 150/85=1.76. For such LEDs the resulting efficiency of the overall lamp system would be (0.55*150+0.4*185+0.05*10)lm/W=157 lm/W, which clearly exceeds the 120 lm/W of the present fluorescent lamp.

In place of or in addition to a yellow-red AlGaInP LED it is also possible to use red AlGaAs LEDs, a combination of several such LEDs with one or more gas-discharge lamps also making good sense. In particular, the use of multiple single light sources of different colors increases the control range for the light coloration, that is to say for the color point of the overall lamp system. At the same it must be remembered that in practice the output of the LEDs can easily be controlled over wide ranges, thereby opening up a particularly simple means of controlling the color point of the lamp system.

The individual light sources may be accommodated in one housing and the mixing components designed as described in DE 200 07 134 U1, which to these ends has been incorporated into this application. For the sake of completeness, however, FIGS. 1 and 2 from this specification and the associated description will be reproduced here making the necessary amendments.

FIG. 1 shows a sectional view through a through a lamp system 1 according to the invention, comprising a housing 2 having a top wall 3, two side walls 4 and a bottom wall 5 together with two side walls which are not visible. The side walls are attached at a sloping angle to the top wall 3, and the bottom wall 5 has a central light outlet aperture 7, which is closed off by a diffuser plate 8. Inside the housing 2 is an elongate fluorescent lamp 6 accommodated on a mount 11, the light from which lamp is prevented from exiting directly through the aperture 7 by a reflector 9 of V-shaped cross-section. The fluorescent lamp 6 emits in the green-blue and thereby provides the green-blue light fractions of the lamp system 1. The green-blue light of the fluorescent lamp 6 is deflected via the walls of the housing 2 to the aperture 7.

In addition, as the plan view from below in FIG. 2 shows, LEDs 10 are mounted on the bottom wall 5, three on either side of the fluorescent lamp 6. Depending on the particular embodiment, the LEDs emit in the yellow-red or in the red and thereby provide the yellow-red or red light fractions of the lamp system 1. By adjusting the intensities of the LEDs it is then possible to control the color point and color temperature of the lamp system 1. In addition, for further control of the color point and the color temperature of the lamp system 1 over a wider range, yet further LEDs may be fitted, which emit in the green and/or in the blue. The fluorescent lamp 6 may also be provided with an intensity control.

With this mixing component setup, the color mixing of the individual light sources is particularly effective, since the directly emitted light is subject to multiple deflections on the walls acting as reflectors, before emerging through the diffuser plate 8. One disadvantage, however, is that losses occur with each reflection. The scope of the invention therefore also extends to other types of mixing arrangements, which use diffusion disks, mirrors and/or integrator rods, for example.

In a further example of an embodiment a whole string of LEDs (represented by dashed lines), which all emit in the yellow-red or red, are used in stead of three LEDs. For extended control of the color point, however, the strings may also contain individual LEDs with emission in the green and/or blue, it being possible to activate the colors separately from one another.

1. A lamp system having
a gas-discharge lamp with a color point in the green-blue,
an LED with a color point in the yellow-red, and
an optical component for additive mixing of the light from the gas-discharge lamp and the LED.

2. A lamp system as claimed in claim 1, characterized in that the gas-discharge lamp is a fluorescent lamp.

3. A lamp system as claimed in claim 2, characterized in that the fluorescent lamp is a low-pressure mercury-vapor lamp, on which in particular the phosphor BAM is applied for the generation of blue light and/or the phosphor CAT is applied for the generation of green light.

4. A lamp system as claimed in claim 1, characterized in that the LED is an inorganic LED, in particular a red-yellow-emitting AlGaInP LED or a red-emitting AlGaAs LED.

5. A lamp system as claimed in claim 1, characterized in that the lamp system is provided with a control component for controlling the color point of the lamp system.

6. A lamp system as claimed in claim 5, characterized in that the control component is designed to control the color point of the lamp system by controlling the power of the gas-discharge lamp and/or the LED.

7. A lamp system as claimed in claim 5, characterized in that the control component is designed to control the color point of the lamp system by controlling the mixing characteristics of the optical component.

8. A method of illumination comprising the following stages:
generation of light with a color point in the green-blue by means of a gas-discharge lamp,
generation of light with a color point in the yellow-red by means of an LED, and
additive mixing of the light from the gas-discharge lamp and the LED by means of an optical component.
